(19) United States
(12) Patent Application Publication
(10) Pub. No.: US 2014/0032233 A1
(43) Pub. Date: Jan. 30, 2014

(54) SYSTEM FOR THE INTERCHANGE OF DENTAL PRESCRIPTIONS

(71) Applicant: Don Bodin, Excelsior, MN (US)

(72) Inventors: Barry Johnson, Minneapolis, MN (US); Don Bodin, Excelsior, MN (US)

(73) Assignee: Don Bodin, Excelsior, MN (US)

(21) Appl. No.: 13/952,112

(22) Filed: Jul. 26, 2013

Related U.S. Application Data
(60) Provisional application No. 61/676,025, filed on Jul. 26, 2012.

(51) Int. Cl. G06Q 50/22; G06Q 10/06

(52) U.S. Cl. CPC G06Q 50/22; G06Q 10/06
USPC 705/2

(57) ABSTRACT

A data processor at a central location includes, a central processing unit, a receiving component to receive prescriptions from dentists, a validation component to insure prescriptions are complete, accurate and comply with any legal or industry standards, an importer to write the prescriptions to a central database, a transmitting component to send the prescriptions to participating dental laboratories, a second receiving component to receive updates related to the production and delivery of the prescribed prostheses, a transmitting component to notify affected parties of changes to the production or delivery status of the prescribed prosthesis.

### RELATED APPLICATION

This application claims priority to U.S. Provisional Application Ser. No. 61/676,025 (entitled A System for the Interchange of Dental Prosthesis Prescriptions and Associated Workflow Information between Dentists and Dental Laboratories, filed Jul. 26, 2012) which is incorporated herein by reference.

### FIELD

The present invention relates generally to the collection, validation, and submission of dental prescriptions and workflow associated with the fulfillment of those prescriptions. Specifically, the invention relates to methods and apparatus for electronic collection of prescriptions, validation of those prescriptions against the fabrication options available at a particular lab, transmission of those prescriptions to an affiliated dental lab and the management of communication between the dentist and the lab related to that prescription.

### BACKGROUND

If a dentist wishes to install a dental prosthesis or device in a patient, it is typically fabricated by a third party dental laboratory or dental lab. This is accomplished by the dentist completing a prescription. These prescriptions are typically completed on pre-printed forms provided by the dental laboratory. Because of the wide variety of devices that can be fabricated, the pre-printed forms used contain entry areas and options for nearly all manner of device and fabrication options though only a portion are applicable to any particular prescription. The relative complexity of these prescription forms tend to result in inaccurate or incomplete prescriptions.

These prescription forms are then delivered, many times along with physical artifacts such as an impression or casting of all or a portion of the patient's teeth or other oral features needed to accurately fabricate the prescribed device.

Upon receipt of the prescription and accompanying artifacts, it is often discovered that the prescription provided is incomplete, internally inconsistent, or otherwise not able to be fabricated as prescribed. These errors may result in an incorrectly fabricated device or further delays in the fabrication process.

In some cases, dental laboratories may in turn subcontract out the production of all or some of the prescriptions they receive from dentists. In such cases these third-party labs (the “fabricating” lab) fabricate the device under direction of the laboratory to which the prescription was initially directed (the “dispensing” lab). In such cases, the dentist is typically naïve to the involvement of the fabricating lab and conducts all communications directly with the dispensing lab.

### SUMMARY

A data processor at a central location includes a central processing unit, an interactive component to capture and validate prescriptions, a receiving component to receive prescriptions, an importer which writes the prescriptions to a central database, a transmitting component which sends the prescriptions to participating dental laboratories, a validation component to insure the responses meet basic standards of compliance and completeness, a business rules engine within the validation component to apply specific standards to validation based on the prescription and the intended laboratory.

### BRIEF DESCRIPTION OF THE DRAWINGS

FIG. 1 is a block diagram of a network for managing the delivery of prescriptions for a plurality of collection dentists and dental labs, in accordance with one embodiment.

FIG. 2 is a flow chart illustrating a process for electronically collecting and distributing prescriptions for dental prostheses, according to one embodiment.

FIG. 3 is a flow chart illustrating a process for electronically collecting and distributing prescriptions for dental prostheses, according to a second embodiment.

FIG. 4 is a flow chart illustrating a method of communicating the production and delivery status of prescribed dental prostheses, according to one embodiment.

FIG. 5 is a flow chart illustrating a method of receiving prescriptions for dental prostheses by a dispensing laboratory and of forwarding those prescriptions to third-party fabricating laboratories and managing the process associated with fulfilling those prescriptions.

FIG. 6 is a block diagram of a computer system suitable for executing methods and implementing servers and clients according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software stored on storage devices, hardware, firmware or any combination thereof. Multiple functions may be performed in one or more modules as desired, and the embodiments described are merely examples. The software may be executed on a digital signal processor, ASIC, microprocessor, cloud based system, tablet, smart phone, mobile computing device, or other type of processor operating on a computer system, such as a personal computer, server or other computer system.

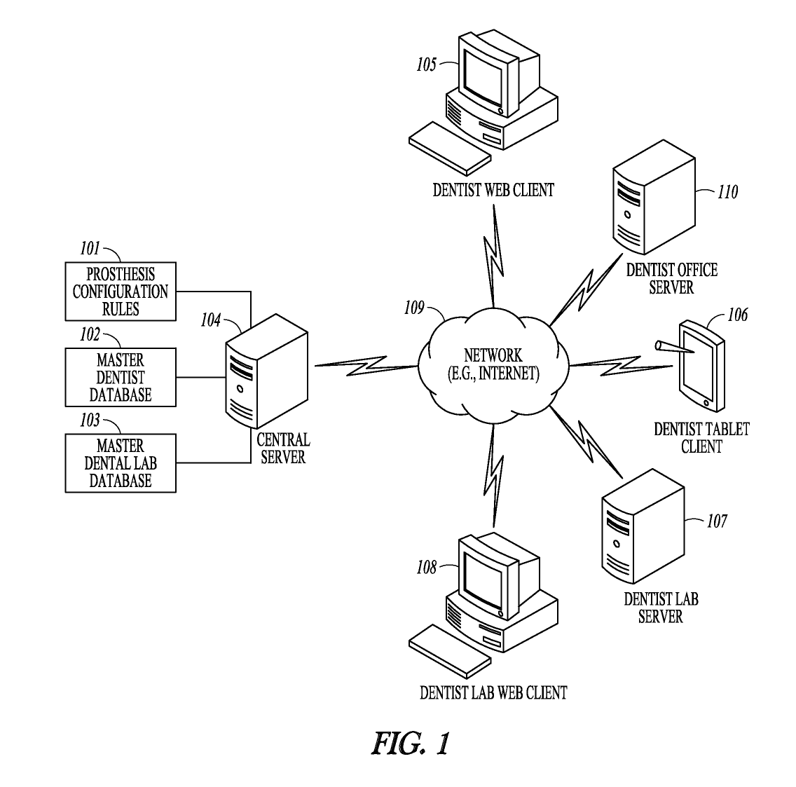

FIG. 1 depicts one embodiment of a network (109) connecting one central server (104) with one or more servers operated by a plurality of dental laboratories (107), zero or more servers operated by a plurality of dentists (110), and manifold web clients used by dental laboratories (108) and dentists (105), often in the form of a tablet or other portable device (106). The central server maintains a collection of cross-industry configuration data including rules related to allowable permutations of options for prescriptions (101), a master database of dental laboratories and information related to their available products and services (102), and a master database of dentists and information related to various standard preferences employed in their prescriptions (103). The central server 104 may be part of a cloud based system, or may be formed using multiple systems in various embodiments, and may further be distributed between many different systems. The master database may be further distributed rather than stored on a single system in various embodiments. There may be separate and different master databases serving various sets of laboratories and dentists in further embodiments.

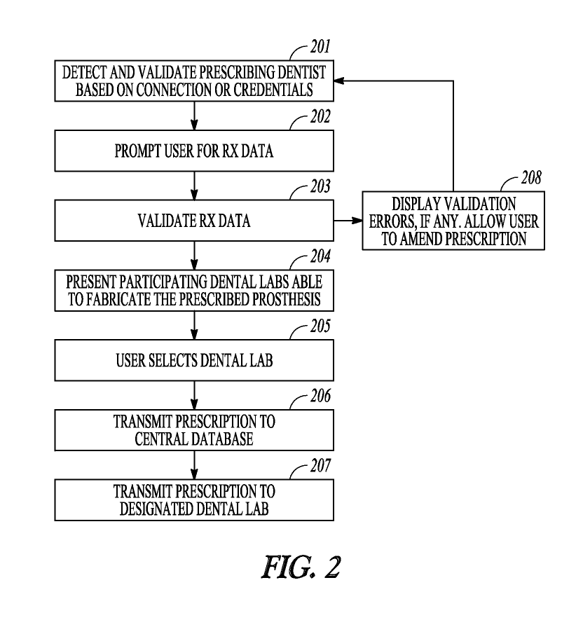

FIG. 2 depicts one embodiment of a process for capturing and transmitting a prescription for a dental prosthesis. This process begins with the detection and validation of an authorized prescribing dentist (201) by a plurality of potential methods including any combination of user credentials, access method, originating network location, or other such methods of user identification and validation which are known to those skilled in the art. After establishing an authorized and validated connection, the dentist creates the prescription via a set of prompts which are dynamically configured and presented based on the various prescribing rules (202).

In one embodiment, the prescription is submitted in whole to the central system at which point it is validated against the master database of prescribing rules (203). In the event of an error or inconsistency in the prescription the prescribing dentist shall be prompted to amend the errant prescription (208). In other embodiments the prescription may be submitted in a series of steps with the display (202), validation (203), and validation error reporting (208) being applied iteratively to portions of the prescription which would collectively comprise a complete prescription suitable for fabrication.

The prescribing dentist is then presented with a list of dental laboratories capable of fulfilling the prescription (204). The list of laboratories is constrained both by the prescription as well as by those labs with which the dentist has established a commercial relationship. Various embodiments may also present further information to aid the dentist in selecting the fabricating dental laboratory, including but not limited to, the quoted price of the prescription, the expected lead time for fabrication and delivery or various quality-related measures of the presented dental laboratories. The prescribing dentist then selects the desired laboratory to fulfill the prescription (205). The prescription is then transmitted to, and stored within, the central database (206). Finally, (207) the system will transmit the prescription to the appropriate dental laboratory. In various embodiments, this transmission may take place via an interactive and human-intermediated messaging facility or it may take place via machine-to-machine communication directly to a server at the dental laboratory. In various embodiments the mode of transmission can be determined dynamically based on the capability of the dental laboratory as well as the nature of the specific prescription being transmitted.

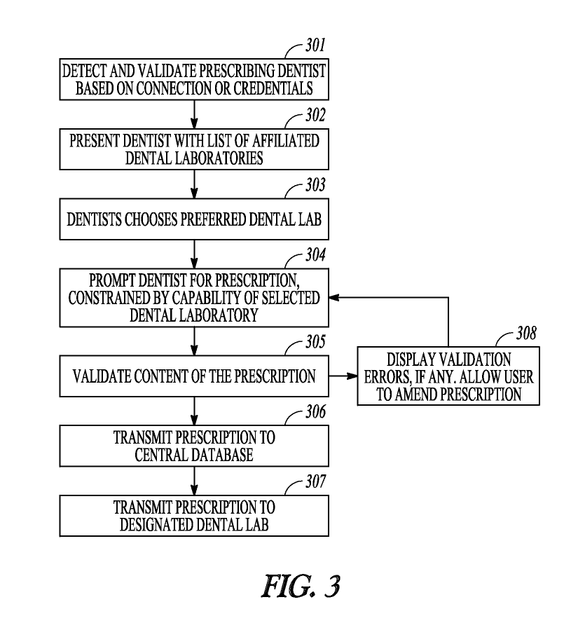

FIG. 3 depicts a second embodiment of a process for capturing and transmitting a prescription for a dental prosthesis. The primary difference between this embodiment and the one depicted in FIG. 2 is the point at which the fabricating dental lab is selected and the implications this has for the process. This process begins with the detection and validation of an authorized prescribing dentist (301) by a plurality of potential methods including any combination of user credentials, access method, originating network location, or other such methods of user identification and validation which are known to those skilled in the art. The user is then presented with (302) a list of dental laboratories with which the active user is affiliated. The dentist would select (303) the dental lab to which the prescription to be written should directed for fulfillment. The dentist creates the prescription via a set of prompts which are dynamically configured and presented based on the various prescribing rules and further adapted or restricted by the selected dental laboratory (304). The process of validating the prescription (305) and presenting errors for correction (308) is substantially identical to the earlier-described embodiment, excepting the addition of validation rules specific to the selected dental laboratory. The prescription is then transmitted to, and stored within, the central database (306). Finally, (307) the system will transmit the prescription to the appropriate dental laboratory. In various embodiments, this transmission may take place via an interactive and human-intermediated messaging facility or it may take place via machine-to-machine communication directly to a server at the dental laboratory. In various embodiments the mode of transmission can be determined dynamically based on the capability of the dental laboratory as well as the nature of the specific prescription being transmitted.

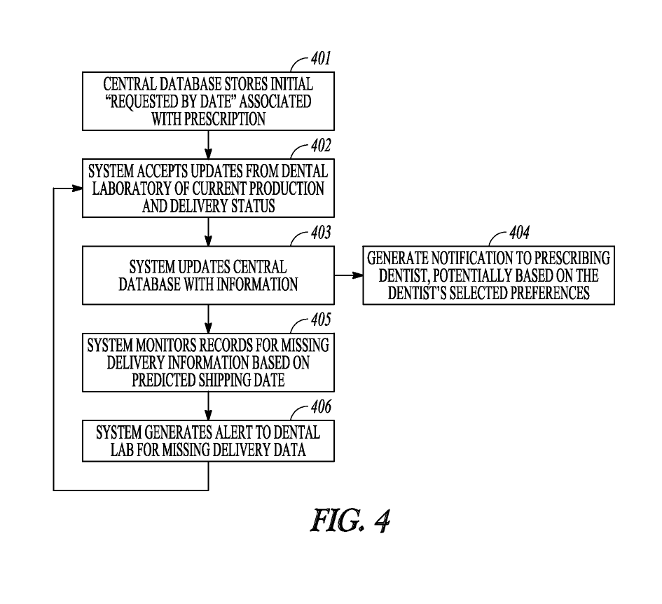

FIG. 4 depicts one embodiment of a process for a central system to mediate the communication of production status and delivery forecast information among a plurality of dental laboratories and a plurality of prescribing dentists. For clarity the illustration is simplified although each interaction between the central system and any external systems or users begins by identifying and authorizing the current user or accessing system by a plurality of potential methods including any combination of user credentials, access method, originating network location, or other such methods of user identification and validation which are known to those skilled in the art.

The process begins when the central system captures the intended date of use of the prescribed prosthesis (401). This date will typically be shortly before the date of expected implantation or application of the prosthesis in the dentist's patient. At any time in the process of fabrication through delivery, the dental laboratory can update the status of the production or delivery of the prescription. In one embodiment, these status updates will be provided on a manual basis by a user accessing the central database through an interface such as a web browser or separate application. In another embodiment, these status updates will be made via machine-to-machine communication with the laboratory's production control, workflow or other system sending automated updates to the central database. The central system then updates the central database (403) with the provided information. The central system then generates a notice (404) to the prescribing dentist about the updated production or delivery status. In one embodiment all updates to status or delivery will be transmitted to the dentist while in other embodiments the update alerts may be filtered or aggregated based on the specific preferences of the dentist and the nature of the update, such that, for example, routine updates might not generate an alert to a dentist while an update indicating a delivery delay would generate an alert.

Regardless of whether updates are made to the system by the dental laboratory, the central system will monitor the database for prescriptions that are approaching the date of expected delivery and will alert the dental laboratory of the need to provide an update of production and delivery information (405). In one embodiment of the system this may employ very simple logic based on a fixed estimated shipping time. In other embodiments this may employ more sophisticated intelligence based on the respective locations of the dentist and dental laboratory as well as the dental laboratory's historical delivery performance. The system then generates and delivers messages to the applicable dental laboratory requesting that they update the status of the prescription (406). As a result of receiving the automated inquiry, the dental lab will be prompted to update the production or delivery status (402). In one embodiment all updates, notifications or alerts will be delivered by the central server in a human readable format such as email. In other another embodiment, some or all updates, notifications or alerts will be delivered by the central server in a machine-to-machine format to software or systems under the control of dentists or dental laboratories.

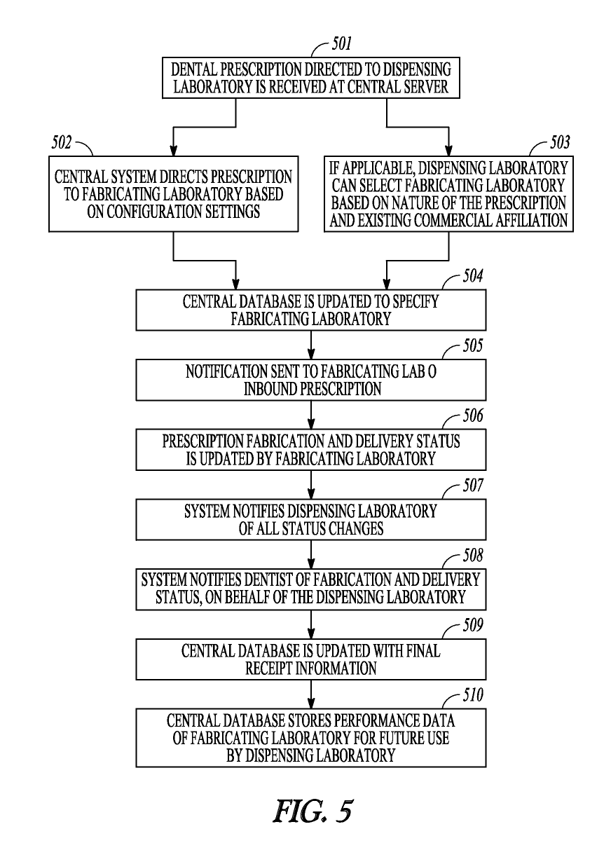

FIG. 5 depicts an embodiment of a process for the fulfillment of dental prosthesis prescriptions in cases where the dental lab to which the prescription was issued (the dispensing laboratory) is forwarded to a different dental laboratory for fabrication (the fabricating laboratory). This process begins (501) with the receipt of the prescription in the central database, viz item 206 of FIG. 2. In one embodiment, the prescription can be automatically routed to a fabricating lab based on the rules and preferences defined by the dispensing laboratory (502). An alternative embodiment or additional capability is for the system to prompt a user at the dispensing laboratory to select a fabricating laboratory manually (503). This manual selection could also be required in the event that the defined routing rules used in 502 are indeterminate in a certain case. The central database is then updated to identify the fabricating laboratory (504). A notice of the incoming prescription is then sent to the fabricating laboratory (505).

For the remainder of this prescription's life, production delivery and other status updates will be initiated by the fabricating lab (506) in a manner consistent with the process illustrated in FIG. 2 and FIG. 3. These updates will be to the dispensing dental lab (507). The updates are then sent to the dentist on behalf of the dispensing laboratory (508) in a manner consistent with the dentist's preferences as described in the exposition of FIG. 4. At the time of receipt of the prosthesis by the dispensing laboratory, information related to the fabricating lab's performance is stored in the central database (509) and is available for future analysis and review by the dispensing laboratory (510). In one embodiment all updates, notifications or alerts will be delivered by the central server in a human readable format such as email. In other another embodiment, some or all updates, notifications or alerts will be delivered by the central server in a machine-to-machine format to software or systems under the control of dentists, dispensing laboratories or fabricating laboratories.

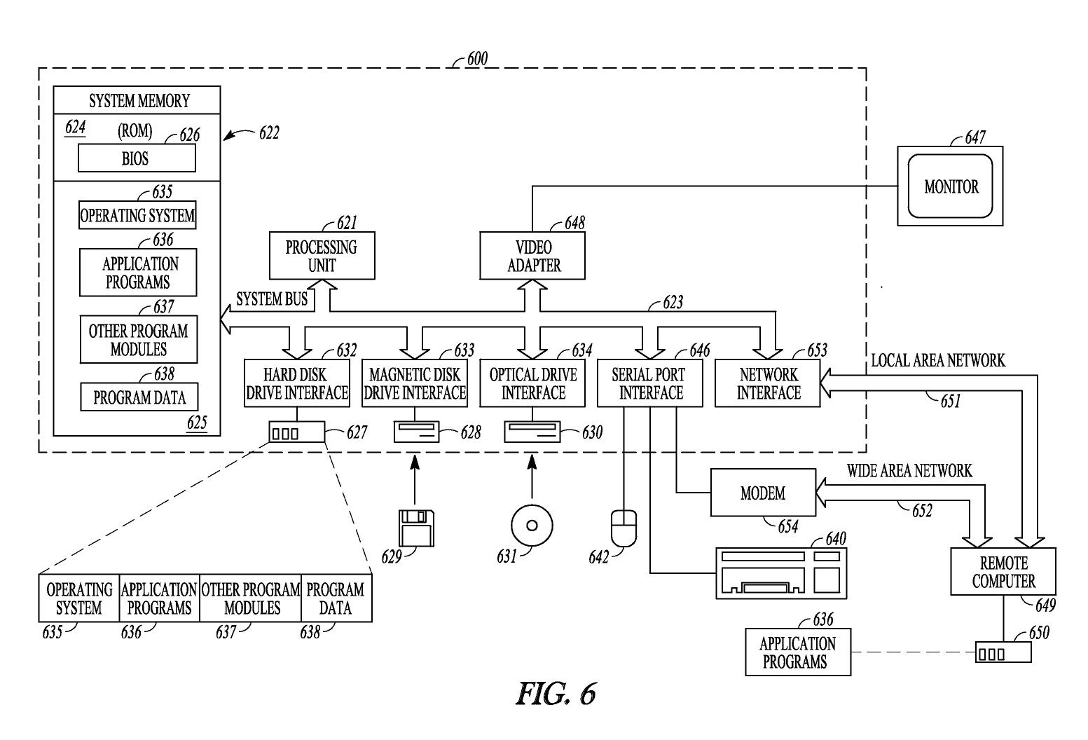

FIG. 6 is a block diagram of a computer system to implement the described methods according to an example embodiment. In the embodiment shown in FIG. 6, a hardware and operating environment is provided that is applicable to any of the servers and clients shown in the other Figures. The computer system may be part of a cloud computing environment in some embodiments. All the components shown in FIG. 6 need not be included in various implementations.

As shown in FIG. 6, one embodiment of the hardware and operating environment includes a general purpose computing device in the form of a computer 600 (e.g., a personal computer, workstation, or server), including one or more processing units 621, a system memory 622, and a system bus 623 that operatively couples various system components including the system memory 622 to the processing unit 621. There may be only one or there may be more than one processing unit 621, such that the processor of computer 600 comprises a single central-processing unit (CPU), or a plurality of processing units, commonly referred to as a multiprocessor or parallel-processor environment. In various embodiments, computer 600 is a conventional computer, a distributed computer, or any other type of computer.

The system bus 623 can be any of several types of bus structures including a memory bus or memory controller, a peripheral bus, and a local bus using any of a variety of bus architectures. The system memory can also be referred to as simply the memory, and, in some embodiments, includes read-only memory (ROM) 624 and random-access memory (RAM) 625. A basic input/output system (BIOS) program 626, containing the basic routines that help to transfer information between elements within the computer 600, such as during start-up, may be stored in ROM 624. The computer 600 further includes a hard disk drive 627 for reading from and writing to a hard disk, not shown, a magnetic disk drive 628 for reading from or writing to a removable magnetic disk 629, and an optical disk drive 630 for reading from or writing to a removable optical disk 631 such as a CD ROM or other optical media.

The hard disk drive 627, magnetic disk drive 628, and optical disk drive 630 couple with a hard disk drive interface 632, a magnetic disk drive interface 633, and an optical disk drive interface 634, respectively. The drives and their associated computer-readable media provide non volatile storage of computer-readable instructions, data structures, program modules and other data for the computer 600. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 629, optical disk 631, ROM 624, or RAM 625, including an operating system 635, one or more application programs 636, other program modules 637, and program data 638. Programming for implementing one or more processes or method described herein may be resident on any one or number of these computer-readable media.

A user may enter commands and information into computer 600 through input devices such as a keyboard 640 and pointing device 642. Other input devices (not shown) can include a microphone, joystick, game pad, satellite dish, scanner, or the like. These other input devices are often connected to the processing unit 621 through a serial port interface 646 that is coupled to the system bus 623, but can be connected by other interfaces, such as a parallel port, game port, or a universal serial bus (USB). A monitor 647 or other type of display device, including a touch screen type device that also provides for user input, can also be connected to the system bus 623 via an interface, such as a video adapter 648. The monitor 647 can display a graphical user interface for the user. In addition to the monitor 647, computers typically include other peripheral output devices (not shown), such as speakers and printers.

The computer 600 may operate in a networked environment using logical connections to one or more remote computers or servers, such as remote computer 649. These logical connections are achieved by a communication device coupled to or a part of the computer 600; the invention is not limited to a particular type of communications device. The remote computer 649 can be another computer, a server, a router, a network PC, a client, a peer device or other common network node, and typically includes many or all of the elements described above I/0 relative to the computer 600, although only a memory storage device 650 has been illustrated. The logical connections depicted in FIG. 6 include a local area network (LAN) 651 and/or a wide area network (WAN) 652. Such networking environments are commonplace in office networks, enterprise-wide computer networks, intranets and the internet, which are all types of networks.

When used in a LAN-networking environment, the computer 600 is connected to the LAN 651 through a network interface or adapter 653, which is one type of communications device. In some embodiments, when used in a WAN-networking environment, the computer 600 typically includes a modem 654 (another type of communications device) or any other type of communications device, e.g., a wireless transceiver, for establishing communications over the wide-area network 652, such as the internet. The modem 654, which may be internal or external, is connected to the system bus 623 via the serial port interface 646. In a networked environment, program modules depicted relative to the computer 600 can be stored in the remote memory storage device 650 of remote computer, or server 649. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A data processor at a central location comprising:
a central processing unit;
a receiving component to receive prescriptions from dentists;
a validation component to insure prescriptions are complete, accurate and comply with any legal or industry standards;
an importer to write the prescriptions to a central database;
a transmitting component to send the prescriptions to participating dental laboratories;
a second receiving component to receive updates related to the production and delivery of a prescribed device;
a transmitting component to notify affected parties of changes to the production or delivery status of the prescribed device.

2. The data processor of claim 1 when at least one of the first or second receiving components is based on the receipt of batch files.

3. The data processor of claim 1 when at least one of the first or second receiving components is based on interactive machine-to-machine communication.

4. The data processor of claim 1 when at least one of the first or second receiving components is based on direct user input via a user interface provided as part of the data processor.

5. The data processor of claim 1 when at least one of the first or second transmitting components is based on the receipt of batch files.

6. The data processor of claim 1 when at least one of the first or second transmitting components is based on interactive machine-to-machine communication.

7. The data processor of claim 1 when at least one of the first or second transmitting components is based on direct user input via a user interface provided as part of the data processor.

8. The data processor of claim 1 when the first receiving and transmitting components receive and transmit data between laboratories rather than between a single dentist and single laboratory.

9. A method comprising:
receiving prescriptions at a server from network coupled dentists;
validating the prescriptions to prescriptions are complete, accurate and comply with any legal or industry standards
selecting a dental laboratory to fulfill the prescription;
writing the prescriptions to a central database;
transmitting the prescriptions to participating dental labs via the network;
receiving updates to production and delivery status from dental labs via the network;
notifying dentists of updates to production and delivery status;
receiving updates of the final receipt and disposition of a prescribed device;
writing the updates to a central database.

10. The method of claim 9 in which the interaction is between two dental laboratories rather than between a dentist and a dental laboratory.

11. The method of claim 10 and further comprising the ability to provide notifications to the prescribing dentist.

12. A system comprising:
a server coupled to a network, the server configured to store prescriptions from prescribing dentists, provide the prescriptions to dental laboratories, and receive status updates from the multiple dental laboratories via the network;
a rules engine stored on a machine readable storage device to provide validation rules to insure prescriptions are complete, internally consistent and comply with legal and industry standards; and
wherein the server is further configured to provide information regarding each prescription to the corresponding prescribing dentist and dental laboratory via the network.

13. The system of claim 12 wherein the server is further configured to manage the distribution of prescriptions from one dental laboratory (the dispensing lab) to a second dental laboratory (the fabricating lab), as well as to maintain segregated and controlled communication channels between the dispensing lab and the prescribing dentist as well as the dispensing lab and the fabricating lab.

14. A system comprising:
a receiving component to electronically receive device prescriptions from dentists;
a validation component to validate prescriptions;
an importer to write the prescriptions to a prescription database;
a transmitting component to send the prescriptions to selected dental laboratories;
a second receiving component to receive status updates corresponding to a prescribed device; and
a transmitting component to communicate changes regarding status of the prescribed device.

15. The system of claim 14 wherein the status corresponds to production and delivery of the prescribed device.

16. The system of claim 14 wherein the prescription is validated against completeness, accuracy, and compliance with legal and industry standards.

17. The system of claim 14 where status updates are received from selected dental laboratories and changes are transmitted to corresponding dentists.

18. A method comprising:
receiving device prescriptions at a server from network coupled dentists;
validating the prescriptions such that the prescriptions are complete, accurate and comply with selected standards
selecting a dental laboratory to fulfill the prescription;
transmitting the prescriptions to participating dental laboratories via the network;
receiving updates to production and delivery status from dental laboratories via the network;
notifying dentists of updates to production and delivery status; and
receiving updates of the final receipt and disposition of the prescribed device.
